(19) United States
(12) Patent Application Publication
(10) Pub. No.: US 2017/0105595 A1
(43) Pub. Date: Apr. 20, 2017

(54) USER INTERFACE FOR A DISHWASHER

(71) Applicant: Electrolux Home Products, Inc., Charlotte, NC (US)

(72) Inventors: Christopher B. Lambert, Charlotte, NC (US); Brain True, Charlotte, NC (US)

(21) Appl. No.: 14/887,643

(22) Filed: Oct. 20, 2015

(51) Int. Cl. A47L 15/00; G06F 3/14; A47L 15/42; G06F 3/0484

(52) U.S. Cl. CPC A47L 15/0021; G06F 3/04847; G06F 3/04842; G06F 3/14; A47L 15/4261; A47L 15/4293; A47L 15/4259; A47L 2301/04; A47L 2401/20; A47L 2401/26; A47L 2501/26

(57) ABSTRACT

Systems, methods, and apparatuses for guiding a user through an interaction with a dishwasher user interface are provided. For example, in one embodiment a method for operating a dishwasher, wherein the dishwasher comprises a tub for receiving dishware, a door configured to enclose the tub, and a user interface comprising one or more control elements, is provided. The method comprises receiving, by the user interface, user selection of at least one of the control elements. In response to receiving the user selection of at least one of the one or more control elements, a controller initiates one or more close door indicators and a countdown timer. The method further comprises determining if the door is closed before a time period of the countdown timer expired. In response to determining that the door was closed before the time period of the countdown timer expired, a wash cycle is started or resumed.

### FIELD

Embodiments of the present invention relate to dishwashing appliances and, more particularly, to systems, methods, and apparatuses for guiding a user's interaction with a dishwasher.

### BACKGROUND

Dishwashers have become an integral part of everyday household use. Consumers place dishware and other utensils onto dishwasher racks inside dishwashers for cleaning. Dishwashers typically clean the dishware with wash systems that utilize spray arms and spray jets to propel water onto the dishware to remove food particles and otherwise clean the dishware.

To initiate or resume a wash cycle, a user may select one or more wash cycle or wash options via a user interface. The user may then indicate, via the user interface, that the wash cycle should start or resume. However, industry standards and requirements sometimes require a user interaction that is not intuitive for the user. For example, recent industry standards and requirements require that to start or resume a wash cycle the user must either interact with the user interface of the dishwasher when the dishwasher door is closed or close the door within four seconds of interacting with the user interface of the dishwasher. Such user interaction with the user interface may not be intuitive to the user and may cause the user to become frustrated and/or displeased with the dishwasher.

### SUMMARY OF THE INVENTION

As described above, a user may interact with a dishwasher user interface in order to cause the dishwasher to start a wash cycle or resume a paused or interrupted wash cycle. However, various required user interactions with the user interface may not be intuitive to the user. Embodiments of the present invention provide methods for guiding a user through an interaction with a user interface, associated user interfaces, and dishwashers having associated user interfaces.

According to one aspect of the present invention, a method for operating a dishwasher is provided. The dishwasher comprises a tub for receiving dishware, a door configured to enclose the tub, and a user interface comprising one or more control elements. In one embodiment, the method comprises receiving, by the user interface, user selection of at least one of the one or more control elements. In response to receiving the user selection of at least one of the one or more control elements, initiating, by a controller, one or more close door indicators and initiating a countdown timer. The method further comprises determining if the door is closed before a time period of the countdown timer expired. In response to determining that the door was closed before the time period of the countdown timer expired, starting or resuming a wash cycle.

According to another aspect of the present invention, a dishwasher is provided. In one embodiment, the dishwasher comprises a tub for receiving dishware, a door configured to enclose the tub, a user interface comprising one or more control elements and one or more close door indicators, and a countdown timer configured to countdown a time period. The dishwasher further comprises a controller. The controller is configured to receive, from the user interface, user selection of at least one of the one or more control elements. In response to receiving the user selection of at least one of the one or more control elements, the controller is configured to initiate one or more close door indicators and initiate a countdown timer. The controller is further configured to determine if the door is closed before a time period of the countdown timer expired. In response to determining that the door was closed before the time period of the countdown timer expired, the controller is configured to start or resume a wash cycle.

According to yet another aspect of the present invention, a computer program product for operating a dishwasher is provided. The dishwasher comprises a tub for receiving dishware, a door configured to enclose the tub, and a user interface comprising one or more control elements. The computer program product comprises at least one non-transitory computer-readable storage medium having computer readable program code portions stored therein. The computer-readable program code portions are configured to, when executed by at least one processor, cause the processor to at least receive, from the user interface, user selection of at least one of the one or more control elements. In response to receiving the user selection of at least one of the one or more control elements, the computer-readable program code portions are configured to, when executed by the at least one processor, further cause the processor to initiate one or more close door indicators and initiate a countdown timer. The computer-readable program code portions are further configured to, when executed by the at least one processor, cause the processor to determine if the door is closed before a time period of the countdown timer expired. In response to determining that the door was closed before the time period of the countdown timer expired, the computer-readable program code portions are configured to, when executed by the at least one processor, further cause the processor to start or resume a wash cycle.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a dishwasher, wherein a portion of the dishwasher is removed to show some internal components, in accordance with some embodiments discussed herein;

FIG. 2 is a block diagram of selective components of dishwasher in accordance with some embodiments discussed herein;

FIG. 3 is a block diagram of selective components of a control unit, in accordance with some embodiments discussed herein;

FIGS. 4A and 4B each show an example user interface, in accordance with some embodiments discussed herein; and

FIGS. 5, 6, and 7 illustrate flowcharts of various processes and operations that may be completed in accordance with some embodiments discussed herein.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

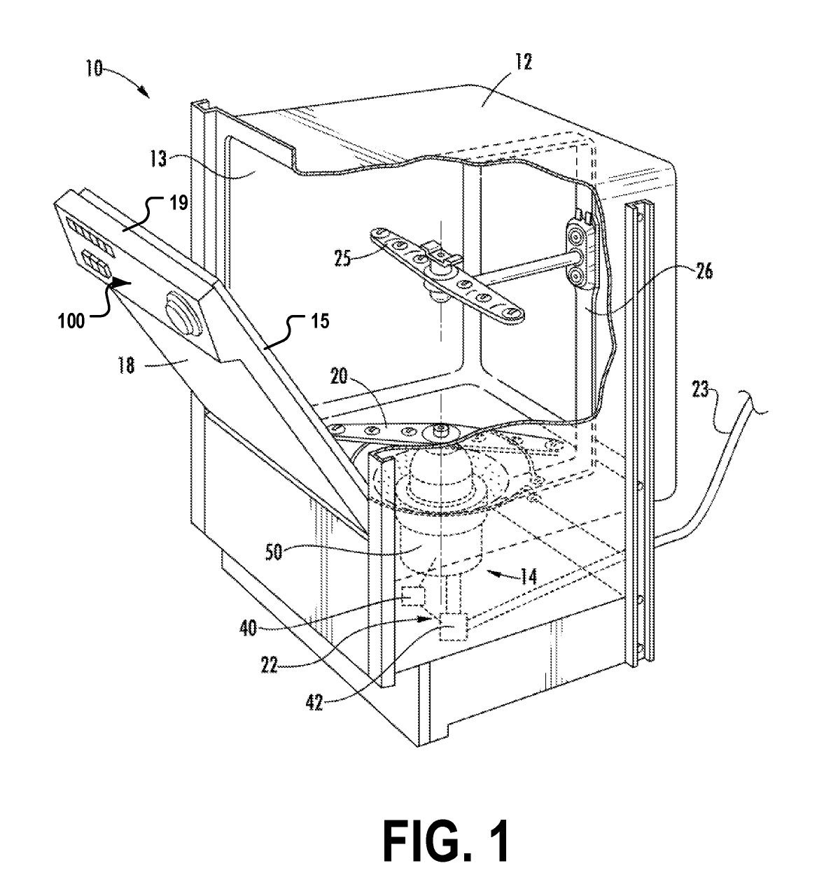

FIG. 1 illustrates one example of a dishwasher 10 capable of implementing various embodiments of the present invention. Such a dishwasher 10 typically includes a tub 12 (partly broken away in FIG. 1 to show internal details), having a plurality of walls (e.g., side wall 13) for forming an enclosure in which dishes, utensils, and other dishware may be placed for washing. A door 15 may be pivotably engaged (e.g., about a hinge) with the tub 12 to selectively permit access to the interior of the tub 12. For example, the door 15 may comprise an open configuration and a closed configuration, such that the door 15 may at least substantially seal the forward access opening of the tub 12 in the closed configuration.

The tub 12 may include a sump 14 in which wash water or rinse water is collected, typically under the influence of gravity. The wash/rinse water may be pumped by a circulation pump 50 to one or more spray arms (e.g., lower spray arm 20, middle spray arm 25) mounted in the interior of the tub 12 for spraying the wash/rinse water, under pressure, onto the dishes, utensils, and other dishware contained therein. For example, the circulation pump 50 may be configured to pump wash water through a circulation hose 26 to the middle spray arm 25 for spraying into the tub 12, such as through one or more spray jets located on the middle spray arm 25.

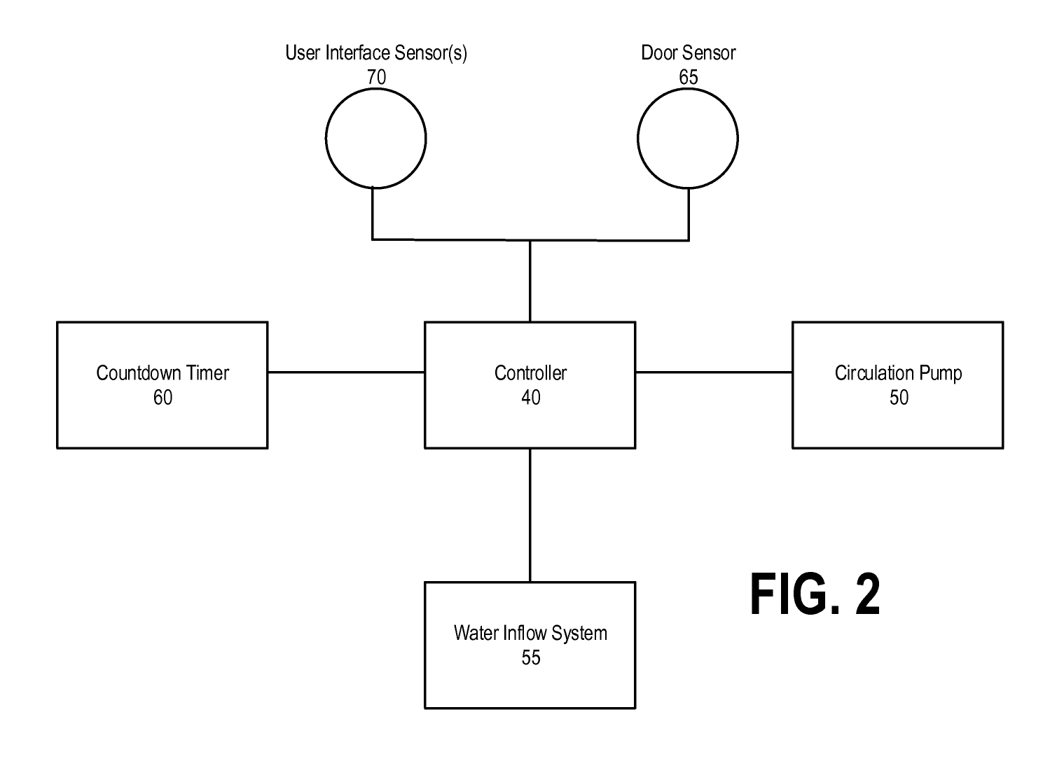

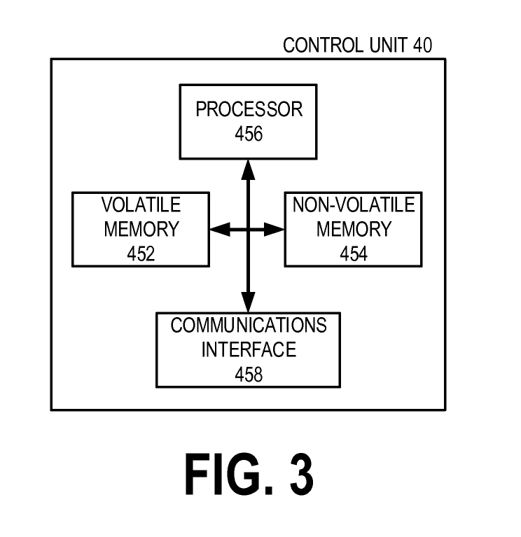

The dishwasher 10 may also comprise a controller 40 that may be in communication with one or more of the operational components of the dishwasher 10. For example, the controller 40 may be in communication with the circulation pump 50 and may be configured to selectively operate the circulation pump 50 to pump wash water to at least one spray arm and/or spray jet. In another example, the controller 40 may be in communication with the water inflow system 55 (shown in FIG. 2) configured to provide water to the dishwasher 10. In various embodiments, the controller 40 may be in communication with a drain pump 42 configured to pump wash fluid out of the dishwasher 10 via drain pipe 23. In some embodiments, the controller 40 may comprise a processor 456 or other computing means such that operations can be performed in the dishwasher as shown in FIG. 3. Additionally or alternatively, the controller 40 may comprise a memory (e.g., volatile memory 452 and/or nonvolatile memory 454) for storage of data such as routines for operation of the dishwasher. In some embodiments, the controller 40 may further comprise a communications interface 458 for communicating with various elements of the dishwasher 10 (e.g., circulation pump 50, door sensor 65, user interface sensor 70, as shown in FIG. 2) or for communicating with one or more computing devices via a wired or wireless network (e.g., the Internet). In some embodiments, the controller 40 may comprise a mechanical timer in addition to or in place of a processor 456. In some embodiments, the controller 40 may be housed in the lower end 22 of the dishwasher 10.

The dishwasher 10 may also include at least one dishwasher rack for holding the dishes, utensils, and dishware. The dishwasher rack can be positioned within the tub 12 to hold dishware for cleaning, such as through wash water that is sprayed onto the dishware from the spray arms and/or spray jets.

The dishwasher 10 further comprises a user interface 100. In various embodiments, the user interface 100 is located on the door 15. For example, the user interface 100 may be located on the front panel 18 of the door 15 or on the top panel 19 of the door 15. In some embodiments having the user interface located on the top panel 19 may cause the user interface to not be accessible when the door 15 is closed.

The user interface may comprise one or more control elements (e.g., buttons, knobs, dials, touch elements, and/or the like) configured to receive input from a user. For example, the user may interact, select, press, rotate, and/or the like one or more control elements. For example, the user interface may comprise one or more control elements configured to provide the user with drying options, pressure options (e.g., spray pressure), temperature options (e.g., wash temperature, drying temperature), wash cycle options, and/or the like. For example, the drying options may comprise heat, air, and extended time drying options. In another example, the pressure options may comprise low, medium, and high options (e.g., for spray pressure of wash fluid sprayed out of the spray arms 20, 25). In still another example, the temperature options comprise wash temperature options such as normal, high temperature, and sanitize options. In yet another example, the wash cycle options include normal, auto, heavy soil, and light soil cycles. One or more user interface sensors 70 may be associated with each control button and be configured to provide the controller 40 with a signal or other indication of the selection of the one or more control elements by the user. The controller 40 may then operate the dishwasher 10 in accordance with the selected control elements. For example, a user may select a control button associated with the heavy soil wash cycle. The user interface sensor 70 associated with the heavy soil wash cycle button may provide a signal to the controller 40 indicating the selection of the heavy soil wash cycle by the user. When the controller 40 next causes the dishwasher 10 to conduct a wash cycle, the controller 40 will cause the wash cycle to be conducted in accordance with the heavy soil wash cycle.

In general, a user operates the dishwasher 10 through interaction with the user interface 100. The controller 40 may be configured to control the dishwasher 10 in accordance with various industry standards/requirements/regulations, which may not always be intuitive to the user. For example, recent industry standards and requirements require that to start or resume a wash cycle, the user must either interact with the user interface when the door 15 is closed or close the door 15 within four seconds of interacting with the user interface. Embodiments of the present invention provide apparatuses and methods configured to guide a user through an interaction with the user interface 100, for example, to start or resume a wash cycle.

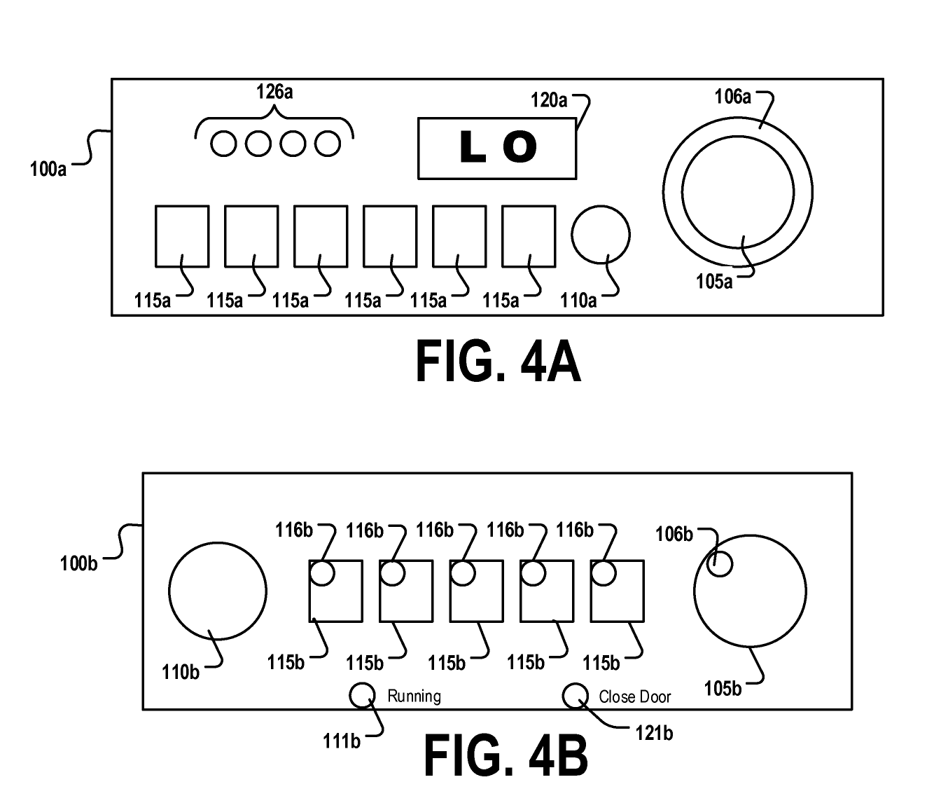

As noted above, a dishwasher 10 may comprise a user interface 100. FIGS. 4A and 4B illustrate some example user interfaces 100a and 100b in accordance with some embodiments of the present invention. In various embodiments, a user interface 100a, 100b may comprise one or more control elements (e.g., buttons, knobs, dials, touch elements, and/or the like). In various embodiments, the one or more control elements may comprise a start element, cycle/options elements, a cancel/reset element, and/or the like. In the embodiments illustrated in FIGS. 4A and 4B, the one or more control elements comprise a start button 105a, 105b, cycle/options buttons 115a, 115b, cancel/reset button 110a, 110b, and/or the like. In various embodiments, the user may select the start element (e.g., start button 105a, 105b) to start and/or resume the wash cycle and/or indicate to the controller 40 that the user would like the wash cycle to start and/or resume. The cycle/options elements (e.g., cycle/options buttons 115a, 115b) may allow the user to select various wash cycles or wash cycle options. For example, the cycle/options buttons 115a, 115b may include one or more of a normal wash cycle button, a heavy soil wash cycle button, a light soil wash cycle button, a quick cycle button, a quiet cycle button, a delay button, a wash zone selection button, an automatic cycle selection button, a heated dry option button, and/or the like. The cancel/reset element (e.g., cancel/reset button 110a, 110b) may be configured to cancel a wash cycle that is currently in progress, reset the selected wash cycle and options to a default selection, and/or the like. As noted above, the control elements may comprise a variety of buttons, knobs, dials, touch elements, and/or the like configured to be interacted with, selected, rotated, pressed, and/or the like by a user to indicate user selection of a control element and/or a wash cycle/option or other command/instruction associated with the control element.

In various embodiments, the user interface 100a, 100b may comprise one or more indicators. The one or more indicators may comprise one or more indicator lights (e.g., LED lights), one or more audible indicators, and/or the like. In various embodiments, the one or more indicators may comprise start element indicator 106a, 106b, timer indicator(s) 126a, display 120a, cycle/option button indicators 116b, running status indicator 111b, close door indicator light 121b, and/or the like. For example, the start element indicator 106a, 106b may be configured to indicate that the user should select or press the start button 105a, 105b, that the user has selected or pressed the start button 105a, 105b, that a wash cycle is in progress, and/or the like. For example, in one embodiment, the start indicator 106a, 106b is an LED light and is configured to blink or pulse when the user should select the start button 105a, 105b, and remains solidly lit after the user selects the start button 105a, 105b until the wash cycle starts/resumes or until the wash cycle completes.

The timer indicator(s) 126a may be configured to indicate the state of a timer associated with the dishwasher 10. For example, as previously described, according to recent industry standards and requirements a user must close the door 15 within four seconds of selecting or pressing the start button 105a, 105b. Therefore, dishwasher 10 may comprise a countdown timer 60 (shown in FIG. 2) configured to count and/or monitor the time between when the user selects or presses the start button 105a, 105b and when the user closes the door 15. The timer indicator(s) 126a may be configured to provide a visible or audible count up to four seconds or count down from four seconds to indicate to the user the time remaining for the user to close the door 15. For example, the timer indicator(s) 126a may comprise four LED lights that light up when the user selects the start button. After one second passes, one of the LEDs may turn off. After another second passes, a second LED may turn off. After the third second passes, a third LED may turn off. After the fourth second passes, the fourth LED may turn off, indicating that the window to close the door has passed. Similarly, an LED may turn on after each second passes until all four LEDs are lit or the door has been closed. In another embodiment, the timer indicator(s) 126a may comprise a single LED that blinks or changes color to indicate the passage of time. For example, the timer indicator may start as a green LED for the first second, switch to a yellow/orange/amber LED for the second second, and switch to a red LED for the third and fourth seconds. In other embodiments, the timer indicator(s) 126a may comprise a light that blinks faster or more brightly to indicate the passage of time and/or an audible indicator such as a tone that gets louder, faster, and/or changes pitch to indicate the passage of time. As should be understood, a variety of timer indicators may be used in accordance with various embodiments of the present invention.

The display 120a may be configured to act as a timer indicator, act as a close door indicator, display a message (e.g., “CLOSE DOOR”, “PRESS START”, “10 MIN LEFT OF CYCLE”, and/or the like), and/or the like. For example, the display 120a may be configured to provide a user with an instruction to close the door, press the start button, and/or the like. For example, the controller 40 may cause text associated with instructing a user to close the door (e.g., “CLOSE DOOR”) to scroll across the display 120a. For example, the message “CLOSE DOOR” may be scrolled across the display 120a two letters at a time. For example, the display 120a may display “CL,” “LO,” “OS,” “SE” “E,” “D,” “DO,” “OO,” “OR” in succession such that a user may perceive the message “CLOSE DOOR” being scrolled across the display 120a. In other embodiments, a message may be scrolled across the display 120a two and a half or three letters/digits at a time. In some embodiments, the message may not scroll but may be displayed in segments or frames. For example, the display 120a may display “CLO,” “SE,” “DO,” “OR” in succession such that the user may perceive the message “CLOSE DOOR.”

In various embodiments, each cycle/option indicator 116b is associated with a cycle/option button 115b. The cycle/option indicator 116b is configured to indicate the selection of the associated cycle/option button 115b. For example, if the user selects or presses the cycle/option button for the heavy soil cycle, the associated indicator light may be lit to indicate the user selection. In various embodiments, the user interface 100 may further comprise a running status indicator 111b configured to indicate that the dishwasher 10 is currently operating, a wash cycle is currently in progress, and/or the like. In various embodiments, the user interface 100 may also comprise a close door indicator light 121b configured to signal to the user that the dishwasher door 15 should be closed. In various embodiments, the user interface 100 may comprise other indicators in addition to or in place of the indicators described herein, as appropriate for the application.

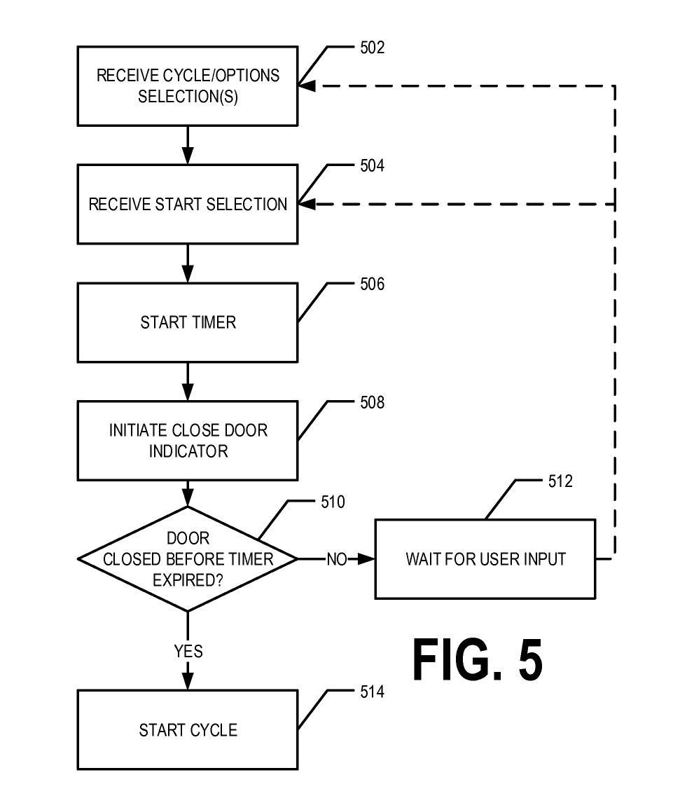

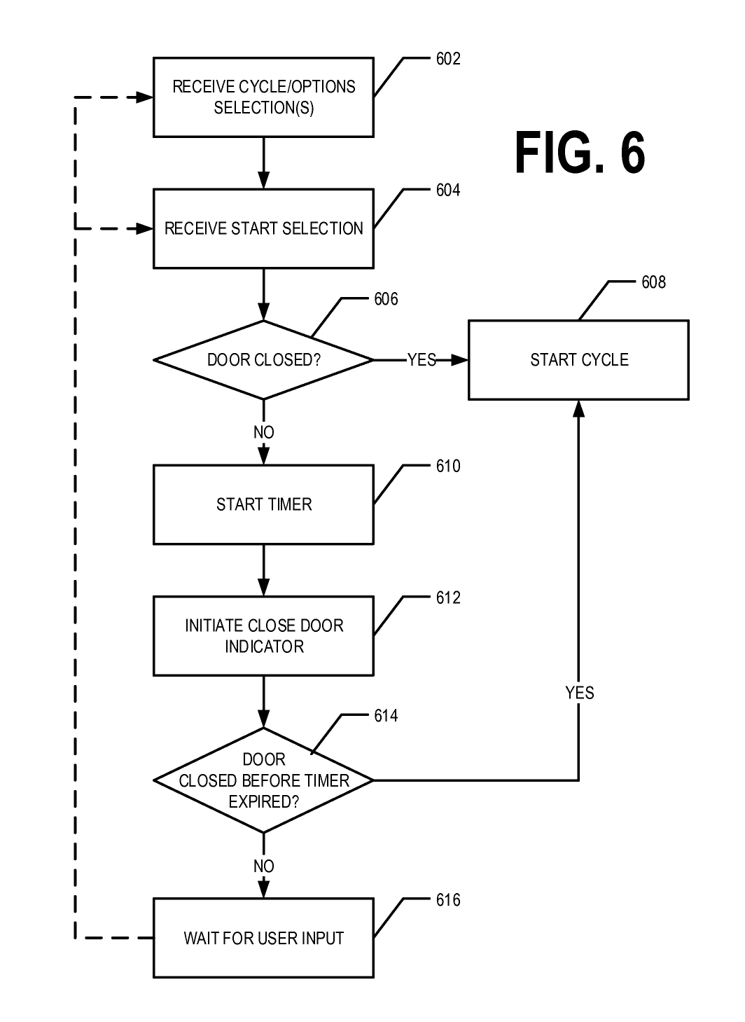

FIGS. 5 and 6 illustrate example methods of guiding a user through an interaction with a user interface 100. These examples relate to a situation wherein a user wishes to start or resume a wash cycle and the dishwasher is configured to operate in accordance with recent industry standards and requirements. As noted above, recent industry standards and requirements require that for a dishwasher cycle to start or resume after being paused (e.g., the door 15 is opened during the wash cycle, a user selects the cancel button 110a, 110b, a user selects the start/pause button, or the like) or interrupted (e.g., a power failure occurs during the wash cycle) the dishwasher door must be closed when the user interacts with the user interface to restart the dishwasher or the user must close the dishwasher door within four seconds of interacting with the user interface to restart the dishwasher.

FIG. 5 provides an example flowchart of processes and operations that may be completed in accordance with an embodiment of the present invention in which the user interface 100 is not accessible when the door 15 of the dishwasher 10 is closed. For example, the user interface 100 may be located on the top panel 19 of the door 15 such if the door 15 is closed, the user interface 100 is not accessible. The process may start at step 502, when user selection of one or more cycle/options buttons is received. For example, the controller 40 may receive one or more signals from one or more user interface sensors 70 indicating user selection of one or more cycle/options buttons. At step 504, user selection of the start button (e.g., 105a, 105b) may be received. For example, the controller 40 may receive a signal provided by one or more user interface sensors 70 indicating the user has selected the start button. In some embodiments, the user may wish to resume a previously started wash cycle, start a default wash cycle, start a previously selected wash cycle with previously selected options, and/or the like and the process may start at step 504. In some embodiments, the controller may cause the start element indicator 106a, 106b to be actuated in a pulsed manner in order to indicate that the user should interact with the start button 105a, 105b. For example, in response to receiving user selection of one or more cycle/option buttons 115a, 115b, the start element indicator 116a, 116b may be made to blink.

After receiving the user selection of the start button, or in response thereto, a timer is started at step 506. For example, in response to receiving the signal that the start button has been selected, the controller 40 may start the countdown timer 60. In some embodiments, the timer may be started in response to user selection of a control button other than the start button. At step 508, one or more close door indicators may be initiated. For example, the controller 40 may cause one or more close door indicators to be initiated. In various embodiments, the close door indicator(s) may be initiated by the controller in response to receiving the signal or other indication that the start button had been selected or pressed. For example, the controller 40 may cause the user interface 100 to prompt the user to close the door 15. For example, the display 120a may display or scroll the message “CLOSE DOOR,” a close door indicator light 121b may be lit or caused to blink, a close door indicator audible may be emitted, a timer indicator 126a may be actuated, and/or the like. In some embodiments, in response to the controller 40 receiving the signal or other indication that the start button has been selected or pressed, the controller 40 may cause the start element indicator 106a, 106b to be lit in a constant manner (in the case where the start element indicator 106a, 106b is a light such as, for example, an LED light).

At step 510, it is determined if the door was closed before the time period associated with the timer expired. For example, as noted above, the user may have a four second time period after selecting the start button 105a, 105b in which to close the door 15. For example, in response to receiving a signal from the countdown timer 60 indicating the time period has expired from the countdown timer 60 before receiving an indication from the door sensor 65 that the door has been closed, the controller 40 may determine that the door was not closed before the time period expired. If the door was not closed during the time period, the controller 40 may wait for further user input (e.g., selection of one or more control elements) at step 512. For example, the display 120a may stop displaying the instruction to the user to close the door and may start displaying an instruction to the user to press the start button 105a, 105b or otherwise indicate to the user that the user should re-select, re-press, or otherwise interact with the start button (e.g., causing the start element indicator 106a, 106b to blink). For example, the close door indicator light 121b may stop blinking and the start element indicator 160a, 106b may start blinking. In another example, in response to the controller 40 receiving an indication from the door sensor 65 that the door was closed before receiving an indication from the countdown timer 60 that the time period has expired, the controller 40 may determine that the door 15 was closed during the time period and may start the wash cycle at step 514. For example, if the controller 40 determines that the door 15 was closed during the time period, the controller 40 may cause the wash cycle to start and/or resume.

FIG. 6 provides an example flowchart of processes and operations that may be completed in accordance with an embodiment of the present invention in which the user interface 100 is accessible when the door 15 of the dishwasher 10 is closed. For example, the user interface 100 may be located on the front panel 18 of the door 15 or otherwise be accessible if the door 15 is closed. The process may start at step 602, when user selection of one or more cycle/options buttons is received. For example, the controller 40 may receive one or more signals from one or more user interface sensors 70 indicating user selection of one or more cycle/options buttons. At step 604, user selection of the start button 105a, 105b may be received. For example, the controller 40 may receive a signal provided by one or more user interface sensors 70 indicating the user has selected the start button 105a, 105b. In some embodiments, the user may wish to resume a previously started wash cycle, start a default wash cycle, start a previously selected wash cycle with previously selected options, and/or the like and the process may start at step 604. In some embodiments, the controller may cause the start element indicator 106a, 106b to be actuated in a pulsed manner in order to indicate that the user should interact with the start button 105a, 105b. For example, in response to receiving user selection of one or more cycle/option buttons 115a, 115b, the start element indicator 106a, 106b may be made to blink.

At step 606, it is determined if the door 15 is closed. For example, in response to receiving the signal or other indication that the start button 105a, 105b has been selected or pressed, the controller 40 may determine if the door 15 is closed. For example, the controller 40 may request and/or receive a signal and/or indication from the door sensor 65 indicating that the door 15 is open or that the door 15 is closed. In some embodiments, in response to the controller receiving the signal or other indication that the start button 105a, 105b has been selected, the controller 40 may cause the start element indicator 106a, 106b to be lit in a constant manner (in the case where the start element indicator 106a, 106b is a light such as, for example, an LED light).

If, at step 606, it is determined that the door is closed, the wash cycle may be started and/or resumed at step 608. If at step 606, it is determined that the door is not closed, the countdown timer 60 is started at step 610. For example, the controller 40 may cause the countdown timer 60 to start. In various embodiments, the countdown timer 60 may be started (e.g., by the controller 40) in response to determining that the door 15 is not closed. At step 612, one or more close door indicators may be initiated. For example, the controller 40 may cause one or more close door indicators to be initiated. In various embodiments, the close door indicator(s) may be initiated by the controller 40 in response to receiving the signal or other indication that the start button 105a, 105b had been selected or pressed and the signal and/or indication that the door 15 is not closed (e.g., the door sensor 65 indicates the door 15 is not closed). For example, the controller 40 may cause the user interface 100 to prompt the user to close the door 15. For example, the display 120a may display or scroll the message “CLOSE DOOR,” a close door indicator light 121b may be lit or caused to blink, a close door indicator audible may be emitted, a timer indicator 126a may be actuated, and/or the like. In some embodiments, in response to the controller 40 receiving the signal or other indication that the start button 105a, 105b has been selected or pressed, the controller 40 may cause the start element indicator 106a, 106b to be lit in a constant manner (in the case where the start element indicator 106a, 106b is a light such as, for example, an LED light).

At step 614, it is determined if the door was closed before the time period associated with the countdown timer 60 expired. For example, as noted above, the user may have a four second time period after selecting the start button 105a, 105b in which to close the door 15. For example, in response to receiving a signal from the countdown timer 60 indicating the time period has expired from the countdown timer 60 before receiving an indication from the door sensor 65 that the door has been closed, the controller 40 may determine that the door was not closed before the time period expired. If the door was not closed during the time period, the controller 40 may wait for further user input (e.g., selection of one or more control elements) at step 616. For example, the display 120a may stop displaying the instruction to the user to close the door and may start displaying an instruction to the user to press the start button 105a, 105b or otherwise indicate to the user that the user should select or press the start button (e.g., cause the start element indicator 106a, 106b to blink). For example, the close door indicator light 121b may stop blinking (e.g., turn off) and the start element indicator 106a, 106b may start blinking. In another example, in response to the controller 40 receiving an indication from the door sensor 65 that the door was closed before receiving an indication from the countdown timer 60 that the time period has expired, the controller 40 may determine that the door 15 was closed during the time period and may start and/or resume the wash cycle at step 608. For example, if the controller 40 determines that the door 15 was closed during the time period, the controller 40 may cause the wash cycle to start and/or resume.

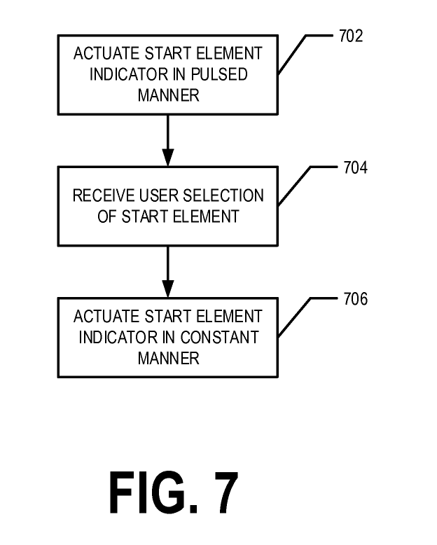

FIG. 7 illustrates a flowchart of another method of guiding a user through an interaction with a user interface 100 of dishwasher 10. Starting at step 702, the start element indicator 106a, 106b may be actuated in a pulsed manner. For example, if the start element indicator 106a, 106b is a light (e.g., an LED light), the light may blink to indicate the user should interact with the start button (e.g., select or press the start button). For example, the controller 40 may receive one or more signals or other indications from the user interface sensor(s) 70 indicating user selection of one or more cycle/option buttons 115a, 115b. In response thereto, the controller 40 may cause the start element indicator 106a, 106b to be actuated in a pulsed manner to indicate the user should interact with (e.g., select or press) the start button 105a, 105b to begin the selected wash cycle. In another example, the controller 40 may determine that a wash cycle has been paused (e.g., via user selection of the cancel button 110a, 110b or by the user opening the door 15) or interrupted (e.g., by a power outage), and may cause the start element indicator 106a, 106b to be actuated in a pulsed manner to indicate the user should interact with (e.g., select or press) the start button 105a, 105b to resume the paused or interrupted wash cycle. In various embodiments, an instruction to select or press the start button may be provided to the user via the display 120a. For example, the instruction “PRESS START” may scroll across the display 120a. For example, the controller 40 may cause the display 120a to display and/or scroll an instruction to the user to press the start button.

At step 704, an indication that the user interacted with the start button 105a, 105b may be received. For example, the user may select or press the start button 105a, 105b. For example, the controller 40 may receive a signal or other indication (e.g., from the user interface sensor(s) 70) that the user has interacted with (e.g., selected or pressed) the start button 105a, 105b.

At step 706, in response to receiving the indication that the user interacted with the start button 105a, 105b, the start element indicator 106a, 106b is actuated in a constant (e.g., non-pulsed) manner to indicate that the user has interacted with the start button 105a, 105b. For example, if the start element indicator 106a, 106b is a light (e.g., an LED light), the start element indicator 106a, 106b may emit a solid or constant light. In various embodiments, the controller 40 may, in response to receiving the signal or indication that the user has interacted with the start button (e.g., from the user interface sensor(s) 70), the controller may actuate the start element indicator 106a, 106b in a constant manner. In embodiments wherein an instruction is provided to the user to press the start button via the display 120a, the instruction may stop being displayed via the display 120a. In some embodiments, a new instruction may then be displayed to the user (e.g., an instruction to close the door) via the display 120a, as appropriate.

FIG. 7 relates to a user interaction with the start button 105a, 105b specifically; however, the method illustrated in FIG. 7 may be applied to any of the control elements of the user interface. Additionally, the method could be applied to a close door indicator. For example, the close door indicator light 121b may blink to indicate the user should close the door 15. Once the door is closed, the close door indicator light 121b may remain lit and emit a solid light (e.g., stop blinking). For example, the controller 40 may cause the close door indicator light 121b to blink or be actuated in a pulsed manner to indicate the user should close the door 15. In response to the controller 40 receiving an indication (e.g., from the door sensor 65) that the door has been closed, the controller 40 may actuate the close door light 121b in a non-pulsed manner, causing the close door light 121b to emit a solid or constant light indicating that the door 15 is closed.

Exemplary embodiments of the present invention include user interfaces configured to guide a user through an interaction with the user interface, a dishwasher comprising a user interface configured to guide a user through an interaction with the user interface, and/or associated methods. Thus, embodiments of the present invention are configured to provide the user with an easy, stress free, and/or frustration free interaction with the dishwasher user interface.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included herein. Although specific terms are employed herein, they are used in a generic and descriptive sense only and not for purposes of limitation.

1. A method for operating a dishwasher, the dishwasher comprising a tub for receiving dishware, a door configured to enclose the tub, and a user interface comprising one or more control elements, the method comprising:
receiving, by the user interface, user selection of at least one of the one or more control elements;
in response to receiving the user selection of at least one of the one or more control elements, initiating, by a controller, one or more close door indicators and initiating a countdown timer;
determining if the door is closed before a time period of the countdown timer expired; and
in response to determining that the door was closed before the time period of the countdown timer expired, starting or resuming a wash cycle.

2. The method of claim 1, wherein initiating one or more close door indicators comprises actuating, in a blinking manner, an LED associated with an instruction to a user to close the door.

3. The method of claim 1, wherein initiating one or more close door indicators comprises causing text associated with instructing a user to close the door to be displayed by a display of the user interface.

4. The method of claim 3, wherein displaying the text comprises at least one of scrolling the text across the display or displaying the text on the display in segments.

5. The method of claim 1 wherein the one or more close door indicators is configured to indicate a time associated with the countdown timer.

6. The method of claim 5 wherein the one or more close door indicators comprises at least one of one or more LED lights or an audible indicator.

7. The method of claim 6 wherein the one or more LED lights are configured to at least one of: emit light of a plurality of colors in succession, blink at an increasing rate, or increase or decrease in brightness to indicate to a user the time remaining to close the door.

8. The method of claim 6 wherein the audible indicator changes in at least one of volume, pitch, or tempo to indicate to a user the time remaining to close the door.

9. The method of claim 1 wherein the one or more control elements comprises a start element, the start element having a start element indicator associated therewith, the method further comprising:
receiving an indication of user selection of at least one of a wash cycle or a wash option via user selection of one or more control elements;
in response to receiving the indication of the user selection, actuating the start element indicator in a blinking manner to indicate that the user should select the start element; and
in response to receiving an indication that the user selected the start element, actuating the start element indicator in a constant manner.

10. The method of claim 9 wherein the start element indicator is an LED light, wherein actuating the start element indicator in a blinking manner causes the LED light to blink, and wherein actuating the start element indicator in a constant manner causes the LED light to stay lit.

11. The method of claim 9, wherein the selected one or more control elements is associated with an LED, wherein the method further comprises actuating the LED associated with the selected one or more control elements in a constant manner.

12. The method of claim 9, wherein the close door indicator is actuated in response to receiving the indication of the user selection of the start element and wherein actuating the one or more close door indicators comprises actuating the close door indicator in a blinking manner to indicate that the user should close the door.

13. The method of claim 9 further comprising, in response to determining that the door was not closed before the time period of the countdown timer expired, actuating the start element indicator in a blinking manner to indicate that the user should re-select the start element.

14. The method of claim 1 further comprising:
receiving user selection of a start element; and
in response to receiving the user selection of the start element, determining if the door is closed,
wherein initiating one or more close door indicators is in response to determining that the door is not closed.

15. The method of claim 1 further comprising, in response to at least one of (a) determining that the door was closed before the time period of the countdown timer expired or (b) determining that the time period of the countdown timer expired, deactivating the close door indicator.

16. A dishwasher comprising:
a tub for receiving dishware;
a door configured to enclose the tub;
a user interface comprising one or more control elements and one or more close door indicators;
a countdown timer configured to countdown a time period; and
a controller, the controller configured to:
receive, from the user interface, user selection of at least one of the one or more control elements;
in response to receiving the user selection of at least one of the one or more control elements, initiate one or more close door indicators and initiate a countdown timer;
determine if the door is closed before a time period of the countdown timer expired; and
in response to determining that the door was closed before the time period of the countdown timer expired, start or resume a wash cycle.

17. The dishwasher of claim 16, wherein to initiate the one or more close door indicators, the controller is configured to actuate, in a blinking manner, an LED associated with an instruction to a user to close the door.

18. The dishwasher of claim 16, wherein to initiate one or more close door indicators, the controller is configured to cause text associated with instructing a user to close the door to be displayed by a display of the user interface.

19. The dishwasher of claim 16 wherein the one or more close door indicators is configured to indicate a time associated with the countdown timer.

20. The dishwasher of claim 19 wherein the one or more close door indicators comprises at least one of one or more LED lights or an audible indicator.

21. The dishwasher of claim 20 wherein the one or more LED lights are configured to at least one of: emit light of a plurality of colors in succession, blink at an increasing rate, or increase in brightness to indicate to a user the time remaining to close the door.

22. The dishwasher of claim 20 wherein the audible indicator changes in at least one of volume, pitch, or tempo to indicate to a user the time remaining to close the door.

23. The dishwasher of claim 16 wherein the one or more control elements comprises a start element, the start element having a start element indicator associated therewith, the controller further configured to:
receive an indication of user selection of at least one of a wash cycle or a wash option via user selection of one or more control elements;
in response to receiving the indication of the user selection, actuate the start element indicator in a blinking manner to indicate that the user should select the start element; and
in response to receiving an indication that the user selected the start element, actuate the start element indicator in a constant manner.

24. The dishwasher of claim 23 wherein the start element indicator is an LED light, wherein actuating the start element indicator in a blinking manner causes the LED light to blink, and wherein actuating the start element indicator in a constant manner causes the LED light to stay lit.

25. The dishwasher of claim 23, wherein the selected one or more control elements is associated with an LED, wherein the controller is further configured to actuate the LED associated with the selected one or more control elements in a constant manner.

26. The dishwasher of claim 23, wherein the controller is further configured to, in response to determining that the door was not closed before the time period of the countdown timer expired, actuate the start element indicator in a blinking manner to indicate that the user should re-select the start element.

27. The dishwasher of claim 16, wherein the controller is further configured to:
receive user selection of a start element; and
in response to receiving the user selection of the start element, determine if the door is closed,
wherein initiating the one or more close door indicators is in response to determining that the door is not closed.

28. The dishwasher of claim 16 wherein the controller is further configured to, in response to at least one of (a) determining that the door was closed before the time period of the countdown timer expired or (b) determining that the time period of the countdown timer expired, deactivate the close door indicator.

29. A computer program product for operating a dishwasher, the dishwasher comprising a tub for receiving dishware, a door configured to enclose the tub, and a user interface comprising one or more control elements, the computer program product comprising at least one non-transitory computer-readable storage medium having computer-readable program code portions stored therein, the computer-readable program code portions configured to, when executed by at least one processor, cause the processor to at least:
receive, from the user interface, user selection of at least one of the one or more control elements;
in response to receiving the user selection of at least one of the one or more control elements, initiate one or more close door indicators and initiate a countdown timer;
determine if the door is closed before a time period of the countdown timer expired; and
in response to determining that the door was closed before the time period of the countdown timer expired, start or resume a wash cycle.

30. The computer program product of claim 29, wherein to initiate the one or more close door indicators, the computer-readable program code portions are further configured to, when executed by the at least one processor, cause the processor to actuate, in a blinking manner, an LED associated with an instruction to a user to close the door.

31. The computer program product of claim 29, wherein to initiate one or more close door indicators the computer-readable program code portions are further configured to, when executed by the at least one processor, cause the processor to cause text associated with instructing a user to close the door to be displayed by a display of the user interface.

32. The computer program product of claim 29 wherein the one or more close door indicators is configured to indicate a time associated with the countdown timer.

33. The computer program product of claim 32 wherein the one or more close door indicators comprises at least one of one or more LED lights or an audible indicator.

34. The computer program product of claim 33 wherein the one or more LED lights are configured to at least one of: emit light of a plurality of colors in succession, blink at an increasing rate, or increase in brightness to indicate to a user the time remaining to close the door.

35. The computer program product of claim 33 wherein the audible indicator changes in at least one of volume, pitch, or tempo to indicate to a user the time remaining to close the door.

36. The computer program product of claim 29 wherein the one or more control elements comprises a start element, the start element having a start element indicator associated therewith, and the computer-readable program code portions are further configured to, when executed by the at least one processor, cause the processor to:
receive an indication of user selection of at least one of a wash cycle or a wash option via user selection of one or more control elements;
in response to receiving the indication of the user selection, actuate the start element indicator in a blinking manner to indicate that the user should select the start element; and
in response to receiving an indication that the user selected the start element, actuate the start element indicator in a constant manner.

37. The computer program product of claim 36 wherein the start element indicator is an LED light, wherein actuating the start element indicator in a blinking manner causes the LED light to blink, and wherein actuating the start element indicator in a constant manner causes the LED light to stay lit.

38. The computer program product of claim 36, wherein the selected one or more control elements is associated with an LED, wherein the controller is further configured to actuate the LED associated with the selected one or more control elements in a constant manner.

39. The computer program product of claim 36, wherein the controller is further configured to, in response to determining that the door was not closed before the time period of the countdown timer expired, actuate the start element indicator in a blinking manner to indicate that the user should re-select the start button.

40. The computer program product of claim 29, wherein the computer-readable program code portions are further configured to, when executed by the at least one processor, cause the processor to:
receive user selection of a start element; and
in response to receiving the user selection of the start element, determine if the door is closed,
wherein initiating the one or more close door indicators is in response to determining that the door is not closed.

41. The computer program product of claim 29 wherein the computer-readable program code portions are further configured to, when executed by the at least one processor, cause the processor to, in response to at least one of (a) determining that the door was closed before the time period of the countdown timer expired or (b) determining that the time period of the countdown timer expired, deactivate the close door indicator.
